(19) United States
(12) Patent Application Publication
(10) Pub. No.: US 2009/0200218 A1
(43) Pub. Date: Aug. 13, 2009

(54) Aquarium sump arrangement

(76) Inventor: Daniel A. Newman, Salem, VA (US)

Correspondence Address: MERCHANT & GOULD PC, P.O. BOX 2903, MINNEAPOLIS, MN, 55402-0903, US

(21) Appl. No.: 12/378,157

(22) Filed: Feb. 10, 2009

Related U.S. Application Data
(60) Provisional application No. 61/065,736, filed on Feb. 13, 2008.

(51) Int. Cl. A01K 63/04; C02F 9/02; C02F 1/20

(52) U.S. Cl. 210/188; 210/257.1; 210/255; 96/155; 210/259; 210/260

(57) ABSTRACT

A sump arrangement for use with an aquarium. The sump arrangement including a dedicated skimmer area that maintains a constant water level to increase operational efficiencies of protein skimmers. The sump arrangement further including a sump tank having an elongated water flow pathway that aspirates air bubbles and improves the clarity of filtered water returning to the aquarium.

### CROSS-REFERENCE TO RELATED APPLICATIONS

This application claims the benefit of U.S. Provisional Application Ser. No. 61/065,736, filed Feb. 13, 2008; which application is incorporated herein by reference.

### FIELD OF THE INVENTION

The present disclosure relates generally to devices for use in the aquatic industry, and various methods associated with such devices. More particularly, this disclosure relates to aquarium sumps for use with aquariums, and methods associated with aquarium sumps.

### BACKGROUND OF THE INVENTION

To maintain an ecological balance within an aquarium, it is necessary to keep the water in the aquarium clean. Cleaning is often accomplished by pumping water from the aquarium to a filtering system, and returning the filtered water to the aquarium. Some cleaning or filtering systems include a sump having a one or more of mechanical, chemical, and biological filtration elements. In general, conventional sumps for filtering aquarium water can be improved.

### SUMMARY OF THE INVENTION

The present invention relates to a sump arrangement for an aquarium. One aspect of the sump arrangement concerns a sump having an elongated water flow pathway that improves the clarity of filtered water. Another aspect of the sump arrangement concerns a dedicated skimmer area that maintains a constant water level to increase operational efficiencies of protein skimmers.

A variety of examples of desirable product features or methods are set forth in part in the description that follows, and in part will be apparent from the description, or may be learned by practicing various aspects of the disclosure. The aspects of the disclosure may relate to individual features as well as combinations of features. It is to be understood that both the foregoing general description and the following detailed description are explanatory only, and are not restrictive of the claimed invention.

### BRIEF DESCRIPTION OF THE DRAWINGS

FIG. 1 is a front perspective view of a sump arrangement, in accordance with the principles disclosed;

FIG. 2 is a top plan view of the sump arrangement of FIG. 1;

FIG. 3 is a front perspective view of the sump arrangement of FIG. 1, illustrating an elongated water flow pathway; and

FIG. 4 is a schematic, top plan view of the elongated water flow pathway of FIG. 3.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

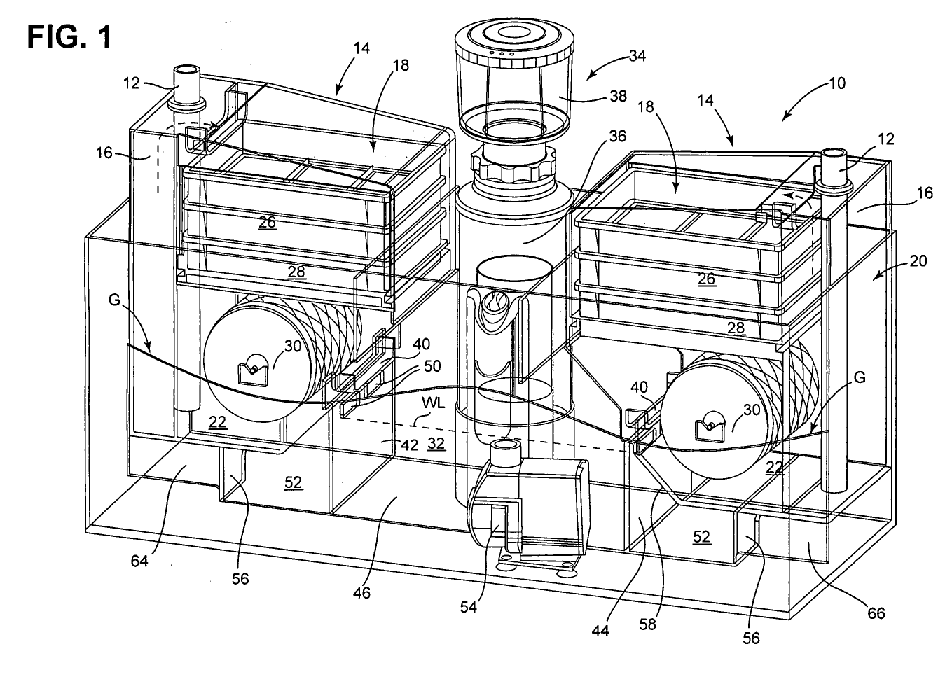

FIG. 1 illustrates one embodiment of an aquarium sump or sump arrangement 10 in accordance with the principles disclosed. As will be described in greater detail hereinafter, the aquarium sump 10 has an elongated water pathway that reduces the amount of air bubbles in the water to improve water clarity with an aquarium tank. The sump 10 further has a dedicated skimmer area that is designed to maximize the efficiency of a skimmer device. While the present sump is describe in use with an aquarium tank, the sump arrangement can be used in other applications, such as a pond application, for example.

The present aquarium sump 10 is used generally to filter aquarium water of an aquarium. The sump 10 collects, filters, and otherwise treats the aquarium water outside of the aquarium tank. In the illustrated embodiment, the sump is a stand-alone sump; meaning the sump is not contained within the interior volume of the aquarium tank itself, and further does not hang alongside or hang over an edge of the aquarium tank. Rather, the sump 10 is typically located beneath the aquarium tank.

Referring to FIG. 1, the sump 10 generally includes a sump reservoir or tank 20 having an interior volume. In use, aquarium water is gravity fed from an aquarium into the sump 10. In particular, water is gravity fed into an incoming vertical tube 12 of a filter module 14 positioned within the interior volume of the sump tank 20. The disclosed sump 10 includes two identical filter modules 14, although only one or more than two filter modules 14 can be provided to accommodate the filtering needs of different applications. In one embodiment, the filter modules 14 are removable so that a user can replace or maintain each module 14 individually and apart from the sump tank 20.

The filter modules 14 each include an incoming reservoir 16 and a filtration region 18. The vertical tubes 12 of each filter module are in fluid communication with the incoming reservoir 16. Water feeding into the sump rises within the incoming reservoir 16 and spills into the filtration region 18 of the filter module 14 (as shown by dashed arrows). In the filtration region 18, the aquarium water falls through filtration media 24 including one or more filter elements.

In the illustrated embodiment, the filtration media of the modules 14 includes mechanical filter elements 26, chemical filter elements 28, and a biological filter element 30. The mechanical filter elements 26 can include various types of mesh constructions designed to capture larger particulates; the chemical filter elements 28 can include carbon-type elements; and the biological filter element 30 can include a rotating cylindrical filtering device. Other types of mechanical, chemical, and biological filter elements can be used; also only one type of filter element or a different combination of filter element types can be used.

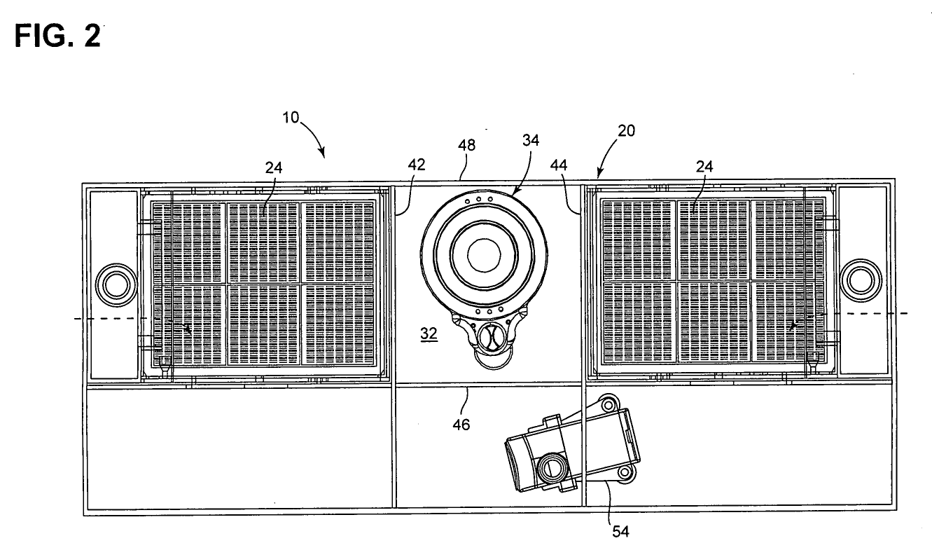

After the water passes through the filtration media 24 of the filter module 14, the filtered water collects within a collection region 22 of the module. As the water level rises in the collection region 22, the filtered water spills over a lip 40 of the filter module 14 into a dedicated skimmer area 32 (see FIG. 2) of the sump 10.

The dedicated skimmer area 32 of the present sump 10 is generally defined by first and second partition wall 42, 44, a mid-wall construction 46, and a rear wall 48 of the sump tank 20. The dedicated area 32 is sized to receive a protein skimmer 34 that filters proteins from the aquarium water. The illustrated protein skimmer 34 generally has a water column chamber 36 and includes a collection cup 38. In use, water within the dedicated skimmer area 32 is drawn into the skimmer 34. Air bubbles are introduced into the water and the aerated water is directed to the water column chamber 36. As the air bubbles of the aerated water rise within the chamber 36, proteins attach to the bubbles and rise to the surface. The proteins are collected in the collection cup 38 until disposed. Further details of a protein skimmer that can be used in the present sump arrangement are provided in U.S. Application No. ______ [having Attorney Docket No. 12742.0123USU1, entitled Protein Skimmer with Stationary Fan]; which application is incorporated herein by reference.

The present dedicated skimmer area 32 is constructed and arranged to receive protein skimmers that are separate and removable from the sump arrangement, such as the skimmer device shown or other aftermarket skimmer devices. That is, the sump 10 does not have a built in skimmer, but rather accepts a protein skimmer within a specific skimmer area of the sump.

Some protein skimmers are adjustable and operate optimally only at a particular setting associated with a specific water level. When the water level in conventional sumps change, the efficiency of the protein skimmer is affected. For example, too high a water level can cause the skimmer to unnecessarily filter already “clean” or filtered water. Too low a water level can result in insufficient water volume filtration. The dedicated skimmer area 32 of the present sump 10 maintains a constant water level for optimal operation of a protein skimmer. That is, the sump 10 continually supplies water to the dedicated area 32 for filtration, yet prevents water level fluctuations that can decrease the filtering efficiencies of a skimmer.

The water level WL of the dedicated skimmer area 32 is maintained by the provision of openings 50 formed in the first and second partition walls 42, 44 of the sump 10. As the water level rises in the dedicated skimmer area 32, the water flows through the openings 50 and into a lower region 52 of the sump 10, i.e., a region located beneath the filter modules 14. The water level WL in the dedicated skimmer area 32 is maintained at the constant level due to the incoming flow from the filter modules 14 and the exiting flow of excess water through the openings 50. As can be understood, the arrangement permits the water level WL in the dedicated skimmer area to be independent of the water level in the remainder of the sump tank 20 during operation of the sump 10. In the illustrated embodiment, the openings 50 are sized to accommodate a flow rate of 700 gallons per hour. Various sized openings can be provided to accommodate the particular flow rates required for an application.

Referring still to FIG. 1, the lower region 52 of the sump IO is constructed and arranged to minimize the amount of air bubbles returned to the aquarium, which air bubbles can disrupt the view and clarity of the water. The minimization of bubbles is achieved by an elongated water pathway in the lower region 52 that allows bubbles to aspirate prior to reaching a return pump 54.

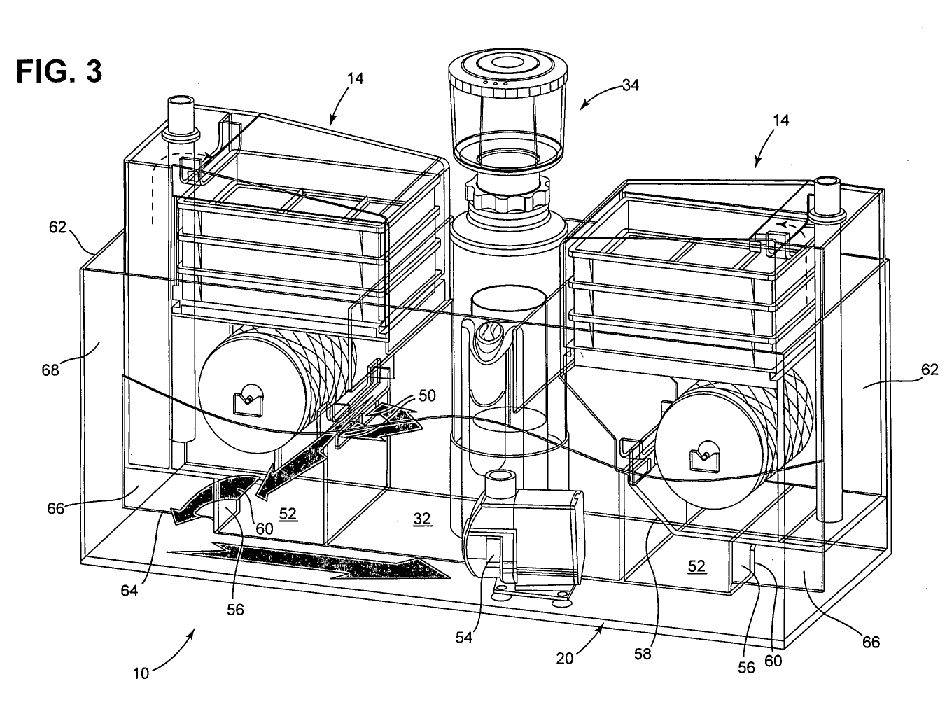

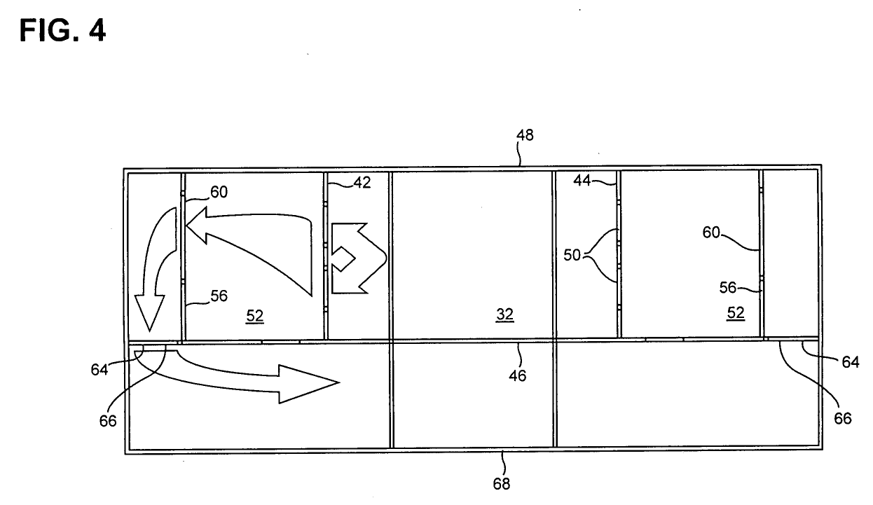

In particular and as previously described, aquarium water cascades through the filtration media and is further filtered by the skimmer that induces air for protein filtration purposes. As can be understood, the introduction of air bubbles can give the filtered water a cloudy appearance when returned to the tank and otherwise take away from the viewing pleasure. In the present sump 10, the filtered water that overflows through the openings 50 in the partitioned walls 42, 44 is drawn by the return pump 54 through a series of passageways and channels. The passageways and channels are defined by baffles or divider walls 56, 66 located in the lower region 52 of the sump 10. Referring to the flow arrows provided in FIGS. 3 and 4, filtered water flows from the openings 50 in the partition wall (e.g., 42) through a passage 60 of a baffle 56. The flow direction at this point along the elongated pathway is sideward toward a side wall 62 of the sump tank 20. The filtered water then flows through another passage 64 in the baffle 66. The flow direction at this point along the elongated pathway is forward toward a front wall 68 of the sump tank 20.

As the water flows through the passages 60, 64 and along the elongated pathway, air bubbles rise and are captured in this region 52 beneath the filter modules 14. The region 52 is submerged, i.e., the region and a substantial portion of the elongated pathway are located below the returning water level within the sump tank 20. Spaces or gaps G are located along the sides of the filter modules 14 to which the air bubbles eventually migrate and naturally vent to atmosphere.

The elongated water pathway in the lower region 52 generally allows bubbles to rise to an upper portion within the pathway while less aerated water continues to flow through the lower region 52. The passageways and channels of water pathway provide an increased distance of travel through a catacomb that reduces water aeration along the flow length of pathway.

In addition, the present elongated water pathway does not utilize aspirating foam or other chemical processes/products to aspirate air bubbles. In conventional applications, the use of foam can clog and damage water pump equipment. The present sump eliminates the need for aspirating foams or similar aspirating products by providing lengthy pathways and passages that permit air bubbles to naturally aspirate.

The filter modules 14 are also constructed to reduce the amount of air bubbles introduced into the returning filtered water. In particular, the filter modules 14 each have an angled wall 58 (FIG. 1) located opposite the openings 50 in the partition walls 42, 44. The angled wall 58 aids in reducing the amount of splashing in the lower region 52 that can cause water to become more aerated. Water overflowing through the openings 50 that would otherwise splash, instead runs down the angled wall and into the lower region 52 in a more controlled manner. This controlled manner of directing water flow reduces aeration of the water.

The above specification provides a complete description of the present invention. Since many embodiments of the invention can be made without departing from the spirit and scope of the invention, certain aspects of the invention reside in the claims hereinafter appended.

What is claimed is:

1. A sump arrangement, comprising:
a) a sump having an interior volume constructed to hold water, the interior volume including a filtering region and a dedicated skimmer region;
b) at least one filter element located within the filtering region; and
c) a skimmer device located within the dedicated skimmer region;
d) wherein the water level in the dedicated skimmer region is independent of the water level in the filtering region during operation of the sump arrangement, and wherein the water level in the dedicated skimmer region is maintained at a constant level during operation of the sump arrangement.

2. The sump arrangement of claim 1, further including a removable filter module, the removable filter module defining the filtering region.

3. The sump arrangement of claim 2, wherein the removable filter module includes a plurality of filter elements located within the filtering region.

4. The sump arrangement of claim 3, wherein the removable filter module includes each of a mechanical filter element, a chemical filter element, and a biological filter element, each of the mechanical, chemical, and biological filter elements being carried by the removable filter module.

5. The sump arrangement of claim 2, wherein the removable filter module includes defines a reservoir and a collection region, wherein:
i) unfiltered, incoming water rises within the reservoir and spills into the filtering region;. ii) the unfiltered, incoming water passes through the at least one filter element and collects in the collection region as filtered water; and
iii) the filtered water rises within the collection region and spills into the dedicated skimmer region.

6. The sump arrangement of claim 1, wherein filtered water that has passed through the filtering region collects within a collection region, the collection region defining a first opening in fluid communication with the dedicated skimmer region.

7. The sump arrangement of claim 6, wherein the sump includes a lower sump region, the dedicated skimmer region defining a second opening in fluid communication with the lower sump region, the second opening being located beneath the first opening such that the water level in the dedicated skimmer region flows through the second opening to maintain the constant level within the dedicated skimmer region during operation of the sump arrangement.

8. The sump arrangement of claim 1, wherein the water enters the filtering region by gravity feed.

9. A sump arrangement, comprising:
a) a sump having an interior volume; and
b) a plurality of channel structures located within a lower region of the interior volume of the sump, the channel structures defining an elongated water flow pathway;
c) wherein air bubbles in the water flowing through the elongated water flow pathway are captured within the lower region beneath the water level of the sump.

10. The sump arrangement of claim 9, wherein the air bubbles migrate and vent to atmosphere through a gap defined in part by structure located beneath the water level of the sump.

11. The sump arrangement of claim 9, wherein the lower region of the sump is located beneath a filtration module, the air bubbles being captured beneath the filtration module.

12. The sump arrangement of claim 11, wherein the air bubble migrate and vent to atmosphere through a gap defined between a wall located within the interior of the sump and the filtration module.

13. The sump arrangement of claim 9, wherein the channel structures define an elongated water flow pathway that directs water flow in a first direction through the lower sump region, and then in a second transverse direction through the lower sump region.

14. A filter arrangement for use in a sump, the filter arrangement comprising:
a) a module defining a reservoir, a filtering region, and a collection region, the collection region being located beneath the filtering region;
b) at least one filter element located within the filtering region, wherein water passing through the at least one filter is collected within the collection region;
c) a spillway in fluid communication between the reservoir and the filtering region;
d) wherein the module defines an opening located adjacent to the collection region such that filtered water rising within the collection region exits the module through the opening, the module further including an angled wall located beneath the opening.

15. The filter arrangement of claim 14, wherein the module is a removable module separate from the sump.
